(19) United States
(12) Patent Application Publication
(10) Pub. No.: US 2026/0329838 A1
(43) Pub. Date: Oct. 22, 2026

(54) Data Processing Method, Apparatus, Device and Storage Medium

(71) Applicant: Beijing Dipeak Technology Co. Ltd, Beijing (CN)

(72) Inventors: Changhua HE, Beijing (CN); Xirong JIANG, Beijing (CN); Yu HU, Beijing (CN); Dongsheng HE, Beijing (CN)

(73) Assignee: Beijing Dipeak Technology Co. Ltd, Beijing (CN)

(21) Appl. No.: 19/490,315

(22) PCT Filed: May 22, 2024
(86) PCT No.: PCT/CN2024/094728

§ 371 Date: Dec. 4, 2025

(30) Foreign Application Priority Data
Jun. 16, 2023 (CN) 202310719381.8

(51) Int. Cl. G06F 16/22

(52) U.S. Cl. CPC G06F 16/2255

(57) ABSTRACT

The embodiments of the present application relate to the technical field of computers. Provided are a data processing method and apparatus, and an electronic device and a computer-readable storage medium. The method comprises: using a first hash function and a second hash function to encode, into a first hash value and a second hash value, each key in key value data to be stored; traversing first hash values and second hash values of all keys in the key value data to be stored, and determining parameter information of a perfect hash corresponding to the key value data to be stored, wherein the parameter information of the perfect hash comprises: an index of a slot corresponding to each key; and storing said key value data to be stored according to the index of the slot corresponding to each key. The solutions of the embodiments of the present application solve the problems of IO overheads of disks being high and the query efficiency being low during data query.

### TECHNICAL FIELD

The present application relates to the technical field of computers, and in particular to a data processing method, an apparatus, an electronic device and a computer-readable storage medium.

### BACKGROUND

One of the most critical functions of a database is data retrieval. Particularly when dealing with a large volume of complex data, how to perform an efficient data search has become a primary challenge for the current database.

Currently, the vast majority of data storage formats are based on an ordered manner, where data is sorted in a certain specified order and then grouped and stored in units of pages or blocks in a storage medium (e.g., an HDD or an SSD). The size of the page is generally consistent with that of a page of a storage system. In a query phase, a data page or block is first located by means of range indexing, and specified content is then found in the data block. Such an algorithm generally has a search efficiency of O(log N), and when there is an extremely large volume of data and an index part thereof cannot be completely cached, the algorithm may incur more disk IO overheads, which greatly reduces the query efficiency.

### SUMMARY

Embodiments of the present application provide a data processing method, an apparatus, an electronic device and a computer-readable storage medium, which can solve the problems of the disk IO overheads being large and the query efficiency being low during data query.

In accordance with a first aspect of the embodiments of the present application, there is provided a data processing method, comprising:
using a first hash function and a second hash function to encode, into a first hash value and a second hash value, each key in key-value data to be stored;
traversing first hash values and second hash values of all keys in the key-value data to be stored, and determining parameter information of a perfect hash corresponding to the key-value data to be stored, wherein the parameter information of the perfect hash comprises: an index of a storage unit (slot) corresponding to each key; and
storing the key-value data to be stored according to the index of the slot corresponding to each key.

In accordance with a second aspect of the embodiments of the present application, there is provided a data processing apparatus, comprising:
a processing unit, which is configured to use a first hash function and a second hash function to encode, into a first hash value and a second hash value, each key in key-value data to be stored; and traverse first hash values and second hash values of all keys in the key-value data to be stored, and determine parameter information of a perfect hash corresponding to the key-value data to be stored, wherein the parameter information of the perfect hash comprises: an index of a slot corresponding to each key; and
a storage unit, which is configured to store the key-value data to be stored according to the index of the slot corresponding to each key.

In accordance with a third aspect of the embodiments of the present application, there is provided an electronic device, comprising: a storage, a processor and a computer program, which is stored on the storage, wherein the processor executes the computer program to implement the data processing method according to the first aspect.

In accordance with a fourth aspect of the embodiments of the present application, there is provided a computer-readable storage medium, which stores a computer program thereon, wherein the computer program, when executed by a processor, implements the steps of the data processing method according to the first aspect.

The beneficial effects brought about by the technical solutions provided in the embodiments of the present application are as follows:
an index of a slot corresponding to each key is determined by means of traversing first hash values and second hash values of all keys in key-value data to be stored, and the key-value data to be stored is stored according to the index of the slot corresponding to each key, such that the size of a data index may be reduced, and the disk IO overheads are reduced during data query, thereby improving the query efficiency, and thus solving the problems of the disk IO overheads being large and the query efficiency being low during data query.

### BRIEF DESCRIPTION OF THE DRAWINGS

In order to explain the technical solutions in the embodiments of the present application more clearly, the drawings needed to be used in the description of the embodiments of the present application will be briefly illustrated below.

FIG. 1 is a schematic structure diagram of an LSM-Tree structure in the related art;

FIG. 2 is a schematic structure diagram of an LSM-Tree of a data processing method provided in an embodiment of the present application;

FIG. 3 is a schematic diagram of a data storage format table based on a perfect hash algorithm provided in an embodiment of the present application;

FIG. 4 is a flowchart of a data processing method provided in an embodiment of the present application;

FIG. 5 is another schematic diagram of a data storage format provided in an embodiment of the present application;

FIG. 6 is a schematic structure diagram of a data processing apparatus provided in an embodiment of the present invention; and

FIG. 7 is a schematic structure diagram of an electronic device provided in an embodiment of the present invention.

### DETAILED DESCRIPTION

Embodiments of the present application will be described below in conjunction with the accompanying drawings of the present application. It should be understood that implementations described below in conjunction with the accompanying drawings are exemplary descriptions for explaining technical solutions in the embodiments of the present application and do not constitute any limitation to the technical solutions in the embodiments of the present application.

It should be understood by those skilled in the art that, as used herein, the singular form “a” “an” or “the” may include plural forms as well, unless otherwise stated. It should be further understood that the terms “comprise” and “comprising” used in the embodiments of the present application denote that a corresponding feature may be implemented as a presented feature, information, data, step, operation, element and/or component, but is not excluded from being implemented as other features, information, data, steps, operations, elements, components and/or combinations thereof supported in the field of art. It should be understood that, when an element is referred to be “connected to” or “coupled to” another element, this element may be directly connected to or coupled to the another element, or it may also refer to establishing a connection relationship between this element and the another element through an intermediate element. In addition, “connecting” or “coupling” used herein may include wireless connection or wireless coupling. The term “and/or” used herein includes at least one of the items defined by the term. For example, the expression “A and/or B” indicates that the implementation is “A”, “B”, or “A and B”.

In order to make the objectives, technical solutions, and advantages of the present application more clear, the embodiments of the present applicant will be further described in detail below with reference to the accompanying drawings.

First, a few terms involved in the present application will be introduced and explained.

The perfect hash algorithm is used to map a given set of K keys to N different values (hash(key_i) is not equal to hash(key_j)_{i is not equal to j}), that is, collision-free hash is achieved.

A log-structured-merge-tree (LSM-Tree) is a data structure for key-value storage, which is a multi-tiered storage structure across memories and disks, rather than a strict tree data structure like a B+ tree or a red-black tree. An increasing volume of data is stored in a top-down structure. The LSM-Tree has the characteristic of using sequential write to improve the write performance. The tiered design may slightly reduce the read performance, but high-performance write is achieved by sacrificing a small part of the read performance, such that the LSM-Tree has become a very popular storage structure.

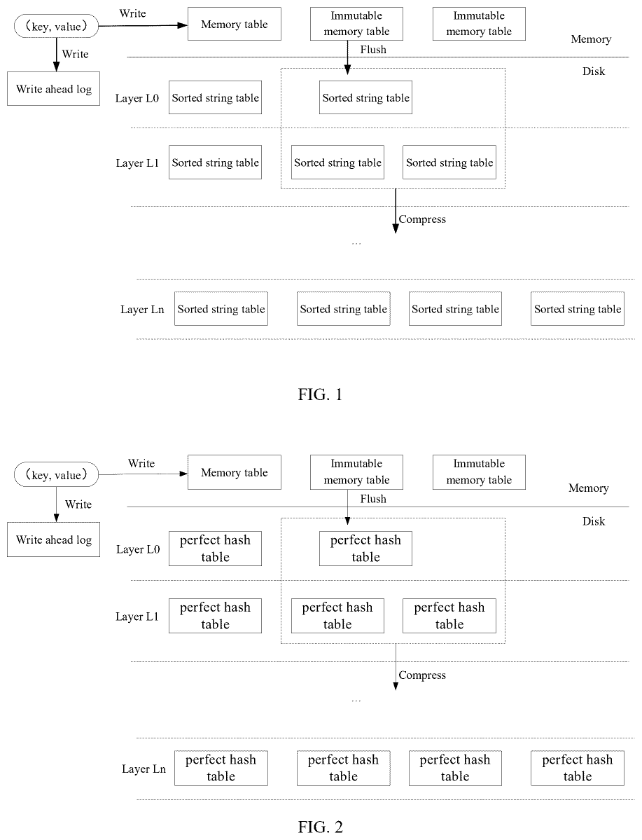

FIG. 1 is a schematic structure diagram of an LSM-Tree structure in the related art. As shown in FIG. 1, the LSM-Tree includes three important components: a MemTable, an Immutable MemTable and an SSTable. Wherein,
MemTable: (a memory table) a data structure of the LSM-Tree in a memory, which is used for saving the latest data and organizing the data in order according to keys.

After the MemTable reaches a certain size, the MemTable is converted into the Immutable MemTable. The Immutable MemTable is an intermediate state during the conversion of the MemTable into the SSTable on the disk. During the conversion, write operations are processed by a new MemTable, without blocking data updating operations.

SSTable: (a sorted string table) a data structure of the LSM-Tree in a disk. The SSTable is a format for storing key-value pairs sorted by keys, which is a sorted structure, and may also be referred to as an ordered string table. One SSTable is composed of a plurality of ordered files, which are referred to as segments, and these segments become immutable once written to disk. Each segment includes a sequence of blocks with configurable size. Indexes of these blocks may be stored at the end of the SSTable to facilitate a quick search of a specific block. When an SSTable is opened, an index table is loaded into a memory. A binary search is then performed in an in-memory index according to a key, and after a disk offset corresponding to the key is found, responded block data is read from the disk.

A flush operation: after a memory in the LSM-Tree reaches its capacity, it is necessary to write data in the memory into a disk and structured as the SSTable. This process is referred to as the flush operation.

A compaction operation: to maintain the tree structure of the LSM-Tree, when the number of SSTable files of a layer Li exceeds a preset value, it is necessary to merge and sort the SSTables of the layer Li and SSTables of a layer Li+1 that have overlapping key values, and also discard some outdated key values. This process is referred to as a compaction operation.

One of the most critical functions of a database is data retrieval. Particularly when dealing with a large volume of complex data, how to perform an efficient data search has become a primary challenge for the current database.

There are related solutions as follows.

Solution I: a hash index is constructed on the SSTable data format. The SST is a data format for sequentially storing data, and is widely used in databases of various key-value types. During the construction of the table, the data is divided into fixed-size blocks (typically 4K), data within each block is arranged in a key order, and a maximum key of each block and file position information of the corresponding block are taken as a new key-value pair to be stored in metadata index blocks in order. During a search, information of the index blocks is read first, a specific block and a file position are indexed by means of binary search according to the keys, and after content of the block is read, corresponding data is then located by means of binary search.

In the solution, a hash index is additionally added to each data block on the basis of the SSTables, thereby improving the point query performance. During the construction of the data blocks, hash calculation is performed on each key, and position information thereof is then recorded in a hash table. If there is a hash collision, i.e., a key is already present at the position, then the position is marked as in an unavailable state. During query, the hash index is queried first. If the position is valid, then the position of the key may be directly located, so as to read data. If the position is invalid, the process may fall back to a binary search algorithm.

Solution II: a Cuckoo Hash table, a Cuckoo Hash algorithm is a hash algorithm that effectively solves hash collisions, with the query time complexity theoretically being a constant, thus having good algorithm characteristics. When a table is constructed using the Cuckoo Hash, n groups of hash algorithms, i.e., n hash tables, are selected first. When a key is inserted, calculation is started from the first hash function. If the position is unoccupied, the insertion succeeds; and if there is data at the position, the data is deleted from the position and new data is then inserted, and the deleted data is inserted again into the next hash table. If there is still data to be evicted in the last hash table, calculation is continuously started from the first hash, and so on. If the number of attempts is too large, it may be necessary to reselect a hash function or enlarge the size of the hash table. During data query, similarly to the insertion flow, a search is started from the first hash table. If matching is not achieved, continue to search the next hash table until the last hash table is reached.

Solution III: a full in-memory index solution of hash+ tree. In this solution, storage position information of all the data is constructed in an in-memory index.

During the construction of a data index, the data is first mapped to different partitions using a hash algorithm, so as to avoiding data skew. A data index of data in the same data partition is constructed using a tree structure, e.g., the red-black tree and the B-tree. Data index information includes metadata information of the data, which includes storage position information, timestamp information, etc. of the data. A fixed-size space is generally selected to store the metadata information. During data query, a partition is first located by means of the hash table, the storage position of the data is then acquired from a tree index structure, and the data is directly fetched from a specific position of a file/disk.

To achieve efficient query performance, most of existing techniques improve the data retrieval efficiency of data by means of optimizing an index, where hash algorithms are preferred choices for most of the optimization solutions due to the good algorithm characteristics. However, current implementations using the hash algorithms still have many defects. Specifically,
regarding solution I, the search efficiency of the index is improved by means of adding the hash index on the basis of the range index. However, when a hash collision occurs, the process directly falls back to the binary search algorithm. The defects of the algorithms similar to the binary search algorithm include: first, having a time complexity being O(log N), which is higher than a constant; and second, during actual algorithm execution, a CPU experiencing a high cache miss, which causes certain CPU overheads. By means of such a solution, impacts of the hash collision are not well solved, which is a certain challenge for a scenario with a higher requirement for a real-time performance.

Regarding solution II, the Cuckoo Hash algorithm with the good algorithm characteristics is used to solve the hash collision. The theoretical query and insertion time complexity of the algorithm is a constant, i.e., the number of hash tables. If there are a small number of hash tables to be selected, more collisions and hash re-calculations may occur during the construction. Too many hash tables means a larger number of IO operations of a query. In actual database applications, to reduce the IO overheads, some databases load a whole data table into a memory for a data search, which also means larger memory consumption.

Moreover, in actual applications of both solution I and solution II, either an S index or a data block needs to be loaded into a memory in advance, and data is then located according to data index information. Such algorithms only accelerate a data indexing speed of the memory, and do not significantly reduce IO of a disk.

In solution III, it is only necessary to load an index of data into the memory, and then locate the specific position of the data according to memory information, while the data does not need to be loaded into the memory in advance. However, the memory solution in solution III is constructed according to a manner of hash+ tree, and the query complexity is thus also O(log n). In actual applications, index information of a single key approximately reaches tens of bytes, and the memory overheads are significant.

The data processing method, the apparatus, electronic device, the computer-readable storage medium and the computer program product provided in the present application aim to solve the technical problems of the existing techniques.

The technical solutions in the embodiments of the present application and the technical effects generated by the technical solutions in the present application will be illustrated below by means of describing several exemplary implementations. It should be noted that the following implementations may refer to, borrow, or be combined with each other. The same terms, similar features or similar implementation steps in the different implementations are not repeated.

FIG. 2 is a schematic structure diagram of an LSM-Tree of a data processing method provided in an embodiment of the present application. As shown in FIG. 2, the LSM-Tree includes: a MemTable, an Immutable MemTable and a Perfect Hash Table (PH Table). Wherein,
MemTable: (a memory table) a data structure of the LSM-Tree in a memory, which is used for saving the latest data and organizing the data in order according to an index sequence of slots corresponding to keys.

After the MemTable reaches a certain size, the MemTable is converted into the Immutable MemTable. The Immutable MemTable is an intermediate state during the conversion of the MemTable into the SSTable on the disk.

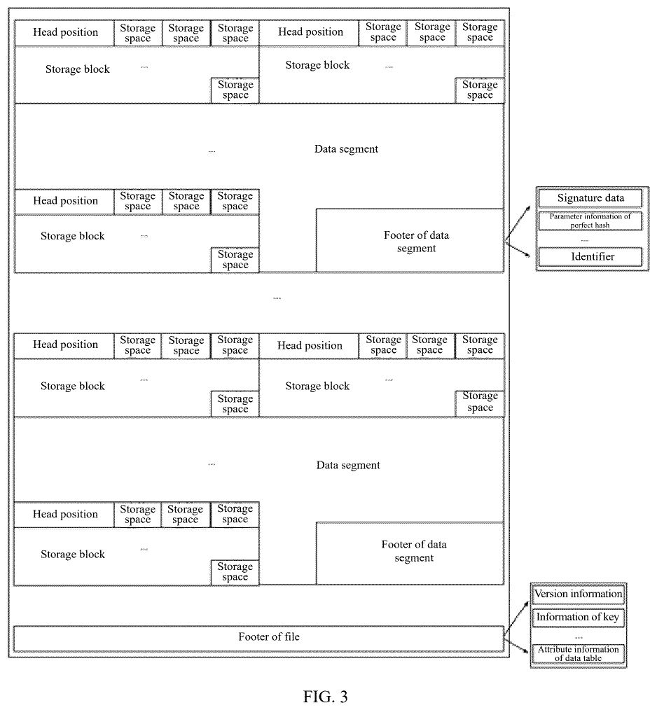

PHTable: (a perfect hash table, Sorted String Table) a data structure of the LSM-Tree in a disk. The PHTable is a data storage format table implemented based on a perfect hash, and is an ordered structure in which sorting is performed according to indexes of the slots corresponding to the keys. As shown in FIG. 3, one PHTable may be composed of a plurality of segments. Each segment includes a sequence of blocks, each block includes a sequence of slots, and each slot is used for storing one key-value pair.

In the embodiments of the present application, a key-value database is constructed based on the LSM-Tree, so as to provide advantages of good read and write performance and a lower cost.

Using the LSM-Tree structure, a database initially stores all the written data in a data structure which takes a memory as a storage medium, and records a write-ahead log (WAL) for recovering data from an abnormal state, thereby ensuring high reliability. When data cached in the memory reaches a certain volume, the cached data is flushed into a persistent storage medium in form of a perfect hash table, which is placed in a layer L0 first. When data in the layer L0 reaches a certain volume, the data is merged with data in a lower layer, so as to generate an updated data table file, and so on. When a query operation is executed, a search is started from the data in the memory. If a key to be found is not present, the search is sequentially performed from a data table of the L0 to a data table of the last layer, until the key is successfully found or the traversing ends.

The present application provides a data storage format table based on a perfect hash algorithm, by means of which the size of a data index is greatly reduced, and it is ensured that disk IO overheads are incurred at most once during data retrieval, thereby providing lower and more stable query latency even when there is mass data.

A data storage solution, a data updating (merging) solution and a data reading solution involved in a data processing method provided in the present application will be described in details below.

First, an implementation process of the data storage solution is described in details.

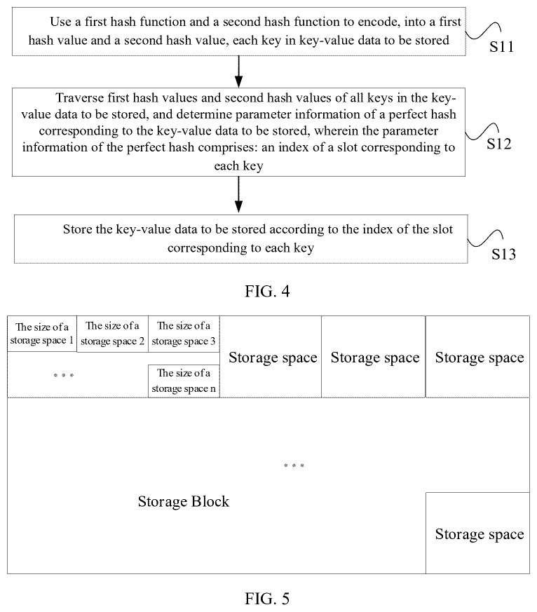

An embodiment of the present application provides a data processing method. As shown in FIG. 4, the method includes the following steps.

In S11, a first hash function and a second hash function are used to encode, into a first hash value and a second hash value, each key in key-value data to be stored.

In S12, first hash values and second hash values of all the keys in the key-value data to be stored are traversed, and parameter information of a perfect hash corresponding to the key-value data to be stored is determined. The parameter information of the perfect hash includes: an index of a storage unit (slot) corresponding to each key.

In S13, the key-value data to be stored is stored according to the index of the slot corresponding to each key.

Specifically, in the embodiment, in step S11, two hash functions (i.e., the first hash function and the second hash function) may be used to map a string of each key in the key-value data to be stored into two 32-bit integers, which are denoted as hash1 (the first hash value) and hash2 (the second hash value). Wherein, the two hash functions may use Djb2Hash and CityHash. In an embodiment of the present application, two independent hash functions are selected in order to increase the dispersion of hashes, facilitating subsequent calculation.

In the embodiment, the index of the slot corresponding to each key is determined by means of traversing the first hash values and the second hash values of all the keys in the key-value data to be stored, and the key-value data to be stored is stored according to the index of the slot corresponding to each key, such that the size of a data index may be reduced, and the disk IO overheads are reduced during data query, thereby improving the query efficiency.

In some embodiments, S12 may include the following steps.

In S121, all the keys in the key-value data to be stored are grouped into a plurality of hash buckets.

In S122, the plurality of hash buckets are sorted in descending order of the number of keys in each hash bucket.

In S123, the plurality of hash buckets are traversed according to the sorting of the plurality of hash buckets, and the parameter information of the perfect hash corresponding to each hash bucket is determined.

Specifically, in the embodiment, firstly, it is necessary to determine a hash bucket load c, i.e., the expected number of keys in each hash bucket. The greater the selected c, the smaller the number of hash buckets, the greater the amount of calculation (the number of retries), and the smaller the volumetric occupancy (the number of parameters) of the hash functions. The smaller the c, the larger the number of buckets, the smaller the amount of calculation, and the larger the volume of the hash functions. Therefore, according to actual situations, c is generally selected to be equal to 5 (c=5), which takes both the amount of calculation and memory consumption into consideration. Thus, the expected number m of buckets is equal to N/c (m=N/c).

According to the perfect hash algorithm, all the keys are divided into a set S1 and a set S2. Wherein, data in the S1 accounts for 60 percent of all the data, and the corresponding number p1 of buckets is 0.3*m (p1=0.3*m). The number of buckets corresponding to the S2 is the remaining part, i.e., m−p1. The bucket of each key is calculated according to the following formula 1:

$$bucket ( key ) = \{ \begin{matrix}{hash}_{1} ( key ) mod p 1 & key ϵ {S}_{1} \\ {p}_{1} + {hash}_{1} ( key ) mod ( m - {p}_{1} ) & otherwise\end{matrix} \qquad Formula 1$$

The hash buckets are sorted in descending order of the number of keys occupied by each bucket.

Started from the first sorted bucket, parameter information of a perfect hash is calculated.

In some embodiments, the parameter information of the perfect hash further includes: a first parameter and a second parameter of the perfect hash corresponding to each hash bucket. Accordingly, S122 may specifically include: determining a first parameter and a second parameter of a perfect hash corresponding to the current hash bucket, and an index of a slot corresponding to each key in the current hash bucket. Wherein, the first parameter and the second parameter of the perfect hash corresponding to the current hash bucket enable the slot corresponding to each key in the current hash bucket to be unoccupied.

In the embodiment, the size n of an initial perfect hash table is determined as being equal to δ_{scale}*N (n=γ_{scale}*N). An initial value of δ_{scale} may be selected as being 1.1, that is, the size of the hash table is slightly larger than the volume of data, such that the probability of a hash collision may be reduced, thereby reducing the calculation time on the premise of increasing a memory space to a certain extent.

Regarding the current hash bucketⱼ, if αⱼ₋₁ (which may correspond to the first parameter mentioned above) and βⱼ₋₁ (which may correspond to the second parameter mentioned above) have been calculated in the previous bucketⱼ₋₁, then parameters of the previous bucketⱼ₋₁ are reused, i.e., αⱼ=αⱼ₋₁ and βⱼ=βⱼ₋₁. A slotᵢ corresponding to each keyᵢ of the bucketⱼ is calculated according to the following formula 2:

slotᵢ=(βⱼ+αⱼ*hash₁(keyᵢ)+hash₂(keyᵢ)mod n Formula 2

If the slotᵢ corresponding to keyᵢ has been occupied, it is necessary to reselect αⱼ and βⱼ for calculation until there is no collision or the greatest number of attempts is reached. If the slotsᵢ corresponding to all the keys in the current bucketⱼ are unoccupied, the current αⱼ and βⱼ are determined.

If α and β of each bucket that meet a condition are successfully found, the parameter information of the perfect hash is determined, and the key-value data to be stored may be stored according to the index of the slot corresponding to each key. If it fails to find α and β of each bucket that meet a condition, γ_{scale} is enlarged to be γ_{scale}+step, (i.e., γ_{scale}=γ_{scale}+step). Wherein, the step may be 0.05, so as to increase the size of the hash table and reduce the probability of a collision. The steps S121 to S123 are repeated until the parameter information of the perfect hash is determined.

In an embodiment, if the current hash bucket is the first sorted hash bucket among the plurality of hash buckets, S122 may specifically include the following steps.

In S1a, for each key in the current hash bucket, an index of a slot corresponding to the key is determined according to the first hash value and the second hash value of the key, an initial perfect hash table, and a first initial parameter and second initial parameter which are randomly selected.

In S2a, if the slot corresponding to each key in the current hash bucket is unoccupied, the first initial parameter is determined to be the first parameter of the current hash bucket, and the second initial parameter is determined to be the second parameter of the current hash bucket.

In S3a, if a slot corresponding to a first key in the current hash bucket has been occupied, the following steps are repeatedly performed.

In S31a, a first initial parameter and a second initial parameter are reselected.

In S32a, an index of a slot corresponding to each key is determined according to the first hash value and the second hash value of each key in the current hash bucket, the reselected first initial parameter and second initial parameter, and the initial perfect hash table.

In S33a, whether the slot corresponding to each key is occupied is determined.

In S34a, if the slot corresponding to each key is unoccupied, the reselected first initial parameter is determined to be the first parameter of the current hash bucket, and the reselected second initial parameter is determined to be the second parameter of the current hash bucket.

Exemplarily, assuming that there are 100 keys and five hash buckets, the hash buckets are sorted in descending order of the number of keys in each hash bucket, i.e., hash bucket 2, hash bucket 3, hash bucket 1, hash bucket 5 and hash bucket 4.

For each key in the hash bucket 2 which is first sorted, an index of a slot corresponding to the key is determined by means of the above formula 2 and according to hash1 and hash2 of each key, an initial perfect hash table (the size n is 110, i.e., the 100 keys are mapped into 100 slots among 110 slots), and parameters α₁ and β₁ which are randomly selected. If the slot corresponding to each key in the hash bucket 2 is unoccupied, α₁ is determined to be the first parameter of the hash bucket 2, and β₁ is determined to be the second parameter of the hash bucket 2. If the slot corresponding to at least one key (e.g., key2) in the hash bucket 2 has been occupied, “the process of reselecting the parameters and performing calculation based on the formula 2” needs to be repeatedly performed until the slot corresponding to each key in the hash bucket 2 is unoccupied or until “the process of reselecting the parameters and performing calculation based on the formula 2” is repeatedly performed a preset number of times but the parameters of the hash bucket 2 have not yet been determined.

In another embodiment, if the current hash bucket is not the first sorted hash bucket among the plurality of hash buckets, S122 may specifically include the following steps.

In S1b, for each key in the current hash bucket, an index of a slot corresponding to the key is determined according to the first hash value and the second hash value of the key, an initial perfect hash table, and a first parameter and a second parameter which correspond to the previous hash bucket.

In S2b, if the slot corresponding to each key in the current hash bucket is unoccupied, the first parameter corresponding to the previous hash bucket is determined to be the first parameter of the current hash bucket, and the second parameter corresponding to the previous hash bucket is determined to be the second parameter of the current hash bucket.

In S3b, if a slot corresponding to a second key in the current hash bucket has been occupied, the following steps are repeatedly performed.

In S31b, a first parameter and a second parameter are reselected.

In S32b, an index of a slot corresponding to each key is determined according to the first hash value and the second hash value of each key in the current hash bucket, the reselected first parameter and second parameter, and the initial perfect hash table.

In S33b, whether the slot corresponding to each key is occupied is determined.

In S34b, if the slot corresponding to each key is unoccupied, the reselected first parameter is determined to be the first parameter of the current hash bucket, and the reselected second parameter is determined to be the second parameter of the current hash bucket.

In the embodiments above, if the repeatedly performed steps have been performed a preset number of times, and a slot corresponding to at least one key in the current hash bucket is occupied, it is determined that the first parameter and the second parameter which correspond to the current hash bucket are not determined.

Continuing with the example above, if the current hash bucket is the hash bucket 1 and parameters of the hash bucket 3 have been determined to be α₂ and β₂, for each key in the hash bucket 1, an index of a slot corresponding to each key is determined by means of the formula 2 above and according to the hash1 and the hash2 of each key, the initial perfect hash table (the size n is equal to 110), and the parameters α₂ and β₂ of the hash bucket 3. If the slot corresponding to each key in the hash bucket 1 is unoccupied, α₂ is determined to be the first parameter of the hash bucket 1, and β₂ is determined to be the second parameter of the hash bucket 1. If the slot corresponding to at least one key (e.g., key28) in the hash bucket 1 has been occupied, “the process of reselecting the parameters and performing calculation based on the formula 2” needs to be repeatedly performed until the slot corresponding to each key in the hash bucket 1 is unoccupied or until “the process of reselecting the parameters and performing calculation based on the formula 2” is repeatedly performed a preset number of times but the parameters of the hash bucket 1 have not yet been determined.

In other embodiments, if a first parameter and a second parameter which correspond to at least one hash bucket among the plurality of hash buckets are not determined, the method further includes the following steps.

In S14 (not shown in the figure), the following steps are repeatedly performed until a first parameter and a second parameter which correspond to each hash bucket among the plurality of hash buckets are determined.

In S1c, the initial perfect hash table is expanded according to a preset step size, so as to obtain a perfect hash table.

In S2c, for each key in a first hash bucket, an index of a slot corresponding to each key is determined according to a first hash value and a second hash value of all keys, the acquired first parameter and second parameter, and the perfect hash table.

In S3c, whether the slot corresponding to each key is occupied is determined.

In S4c, if the slot corresponding to each key is unoccupied, the acquired first parameter is determined to be a first parameter of the first hash bucket, and the acquire second parameter is determined to be a second parameter of the first hash bucket.

In S5c, if a slot corresponding to a third key in the first hash bucket has been occupied, the following steps are repeatedly performed.

In S51c, a first parameter and a second parameter are re-acquired.

In S52c, an index of a slot corresponding to each key is determined according to the first hash value and the second hash value of each key, the re-acquired first parameter and second parameter, and the perfect hash table.

In S53c, whether the slot corresponding to each key is occupied is determined.

In S54c, if the slot corresponding to each key is unoccupied, the re-acquired first parameter is determined to be the first parameter of the first hash bucket, and the re-acquired second parameter is determined to be the second parameter of the first hash bucket.

Specifically, in the embodiment, if the first hash bucket is a first sorted hash bucket among the plurality of hash buckets, the acquired first parameter and second parameter are a first parameter and a second parameter which are randomly selected. If the first hash bucket is not the first sorted hash bucket (for example, a second sorted hash bucket) among the plurality of hash buckets, the acquired first parameter and second parameter are a first parameter and a second parameter of the previous hash bucket (e.g., the first sorted hash bucket).

That is to say, if the steps S31a to S34a and/or the steps S31b to S34b in the embodiment have been repeatedly performed a preset number of times, e.g., 100 times, and a slot(s) corresponding to one or more keys in the first hash bucket is/are unoccupied, it fails to find a first parameter and a second parameter of each hash bucket that meet a condition. In this case, parameter information of a perfect hash may be re-calculated by means of expanding the perfect hash table.

Continuing with the example above, if the steps S31b to S34b have been repeatedly performed for the hash bucket 5 a preset number of times but corresponding parameters are not determined, that is, a collision occurs when 100 keys are mapped to 100 slots among 110 slots, the initial perfect hash table (the size n is equal to 110) is expanded to the perfect hash table (the size n is equal to 115, i.e., the 100 keys are mapped to 100 slots among 115 slots), and the parameter information of the perfect hash is re-calculated from the hash bucket 2 to the hash bucket 4. Wherein, for the calculation regarding the hash bucket 2, reference may be made to the steps S1a to S34a, and for the calculation regarding each hash bucket among the hash bucket 3, the hash bucket 1, the hash bucket 5 and the hash bucket 4, reference may be made to the steps S1b to S34b, which will not be repeated here for brevity of the description.

In some embodiments, the step S13 in the embodiment may specifically include:
writing the key-value data to be stored into at least one storage block according to the index of the slot corresponding to each key, where the number of slots stored in each storage block is determined based on the size of the unit of storage of a storage device; and
writing the at least one storage block into the storage device after compressing the at least one storage block.

In the embodiment, length information of each slot may be written into a head position of the corresponding storage block according to the index of the slot corresponding to each key, and key-value data in each slot may be sequentially written into the corresponding storage block. Reference may be made to FIG. 5 for details.

It should be noted that the size of the storage block (the number of slots stored) may be selected to keep consistent with the size of a page of a disk or memory.

Exemplarily, when one storage block may store 20 slots, the 100 slots are sequentially written into 20 storage blocks according to indexes of the 100 slots. For example, the slots with the indexes being 1 to 20 are written into a storage block 1. Assuming that the slots with the indexes being 21, 38 and 40 are empty, the slots with the indexes being 22 to 43 are written into a storage block 2.

It should be noted that, in the embodiment, the indexes of the slots may correspond to (for example, a key 2 is stored in a slot 2) or not correspond to (for example, a key 10 is stored in a slot 5) the order of the keys.

To further reduce the size of a data file, data in each storage block may be compressed in a file compression manner, and then written into a storage device.

In the embodiment, the method may further include:
recording file offset position information of each storage block, so as to obtain offset data; and
determining a part of the first hash value or the second hash value of each key to be signature information of each key, so as to obtain signature data.

Wherein, the writing the at least one storage block into the storage device after compressing the at least one storage block include:
generating a data table file based on the at least one compressed storage block, the offset data, the signature data, the parameter information of the perfect hash, and attribute information of a data table; and
writing the data table file into the storage device using a log-structured-merge-tree (LSM-Tree) structure.

In the embodiment, when each storage block is written into a file, offset position information of the file in which the block is located is recorded. Signature information of a key in each slot may also be calculated. For example, the last eight bits of a second hash value of each key is taken as signature information of the corresponding key:

signature(keyᵢ)=hash₂(keyᵢ)&0XFF Formula 3

The signature information of keys in all the slots forms a signature array (which may correspond to the signature data above), the function of which is to filter out absent data during query. Any key may be mapped to a valid slot based on the formula 2, and accordingly, if a certain key does not match signature information of a corresponding slot, this indicates that the key is certainly not present in the slot and may be directly ignored, thereby reducing the file reading overheads.

After all the blocks have been written, offset information of each block, the signature array, the parameter information of the perfect hash and the attribute information of the data table are together written into footer of the file, so as to generate a data table file.

Exemplarily, for the specific format of the data table file in the embodiment, reference may be made to the content as shown in FIG. 3. Wherein, the attribute information of the data table may include one or more of the following pieces of information: version information of the data table, the number of keys in the data table, the average size of keys and values in the data table, the type of a compression algorithm, etc.

It should be noted that, in the embodiment, the last eight bits or the first eight bits of a first hash value of each key may also be taken as signature information of the corresponding key, which is not limited in the embodiments of the present application.

The data table file is generated based on static data. In a real-time updating scenario, data may continuously change overtime, where new key-value is inserted and old key-value is deleted or updated, and thus, the data table also needs to be dynamically updated to provide the query of new data.

Therefore, the embodiments of the present application also provide a data updating (which may alternatively be referred to as data merging) method. In view of the structure of the LSM-Tree, each time new data is written (new data is inserted or old data is updated), the data is written into a memory table first. When the size of the memory table reaches a certain threshold, the memory table is marked as in a non-updatable state, and a new memory table is re-generated for subsequent writing. The non-updatable data table then becomes a static data set, the data in which is written into a layer L0 (the uppermost layer) in the format of a perfect hash table. When the data volume of the layer L0 reaches a certain threshold, the data of the L0 is merged with data of a lower layer, and so on.

That is to say, if the volume of key-value data written into a first memory table reaches a second preset threshold, the first memory table is marked as in a non-updatable state, and the key-value data in the first memory table is determined to be the key-value data to be stored.

Data stored in a traditional LST-Tree is arranged in ascending order of keys, and accordingly, a file merging operation is typically performed by means of Merging and Sorting. However, in the present application, stored data is arranged in ascending order of the indexes of the slots corresponding to the keys, and the file merging operation of the traditional LST-Tree is thus not suitable for the present application. Therefore, the present application uses solutions in the following embodiments.

The writing the data table file into the storage device using the LSM-Tree structure includes performing at least one of the following operations:
writing the data table file into the layer L0 of the LSM-Tree structure; and
if a first data file stored in a layer Li reaches a first preset threshold, merging the first data file into a layer Li+1, where i is 0 to n, and n is a positive integer greater than 1.

In an embodiment, the merging the first data file into the layer Li+1 includes:
if the layer Li+1 does not store data, directly writing the first data file into the layer Li+1; and
if the layer Li+1 has stored a second data file, respectively dividing the first data file and the second data file into S data segments according to hash values of keys, and performing the following operations for a jth data segment of the first data file and a jth data segment of the second data file:
acquiring a first hash value and a second hash value of all keys in the two jth data segments;
determining an index of a slot corresponding to each key according to the first hash value and the second hash value of each key; and
determining a corresponding operation according to the key-value data in each slot,
where S is a preset value greater than 1, and j is 1 to S.

In the embodiment, the determining the corresponding operation according to the key-value data in each slot includes:
if the current slot is empty, determining not to perform any operation;
if the key-value data in the current slot is key-value data in the first data file or key-value data in the second data file, determining to perform the step of writing the key-value data in the current slot into the storage device according to an index of the current slot; and
if the key-value data in the current slot includes the key-value data in the first data file and the key-value data in the second data file, determining to write new key-value data into the current slot, and to perform a step of writing the new key-value data in the current slot into the storage device according to the index of the current slot.

Wherein, the new key-value data is obtained based on the key-value data in the first data file and the key-value data in the second data file.

Specifically, in the present embodiment, a new data file (which may correspond to the first data file) is marked as delta, and an old data file (which may correspond to the second data file) is marked as base. To reduce the memory occupation and increase the degree of concurrency, the data file is divided into S segments according to the hash values of the keys:

segment(keyᵢ)=(hash₁(keyᵢ)+hash₂(keyᵢ))mod S

In this way, pieces of data in the respective segments are independent of each other, and may thus be concurrently processed at the same time.

The following operations are performed on a jth segment in the delta data and a jth segment in the base data until the S segments are traversed.
1. All keys in the jth segment in the delta data and in the jth segment in the base data are acquired, and a hash1 and a hash2 of each key are calculated.

To reduce the amount of calculation, the hash1 and the hash2 may also be persisted into the data file in a file generation stage to be directly read, so as to reduce the calculation overheads.
2. For all the acquired keys, the indexes of the slots are calculated according to the process of realizing data storage in the embodiments above, and the delta data and the base data that belong to the same slot are aggregated.

The specific cases in each slot include:
A. the slot is empty;
B. the slot only includes the delta data;
C. the slot only includes the base data; and
D. the slot includes both the delta data and the base data.

The case A may be directly ignored. In the case B (the data is newly added) or the case C (the data is not modified), data may be written into a new file without needing a merging operation on the data. In the case D (old data is updated), an updating operation is required, and the final updated data is stored in the corresponding slots. With reference to the content as shown in FIGS. 3 and 5 and the related description, the data is then organized and written into the new data file, completing the merging of the data file.

In the embodiment, the specific updating operation may be a customized operation based on actual requirements of a user. For example,
function I: data is directly overwritten, where in the case D, the base data is overwritten by the delta data, and data in the slot in a new file is delta data.
Function II: the base data is an accumulation of the delta data, where if the base data is a numerical value and the delta data is an accumulation operation, the data in the slot in the new file is the result of the base data plus the delta data. Exemplarily, in the scenario of bank deposit and withdrawal transactions, the base data is “depositing—1 million”, the delta data is “withdrawing—100 thousand”, and the updated data is “depositing—9 million”.

In the embodiments of the present application, by means of a data table using the perfect hash algorithm as a data index, query can be performed with at most one IO overheads.

In addition, according to the merging method for the data table, new data and old data at the same position are merged by grouping using the characteristics of a perfect hash, and the merging flow is optimized according to whether there is the new data.

The data index table using the perfect hash algorithm is combined with the LSM-Tree to form a complete key-value DB database.

In addition, an embodiment of the present application further provides a data processing method, which is used for realizing data reading (which may also be referred to data query). On the basis of the embodiment, the method may also include the following step.

At S15 (not shown in the figure), in response to a received read instruction, corresponding key-value data is read from data table files in the storage device. Wherein, the read instruction is used for instructing the reading of key-value data of a specific key.

In the embodiment, the process of reading the key-value data of the specific key may include:
if the specific key is found in the memory table, reading the key-value data corresponding to the specific key;
if the specific key is not found in the memory table, traversing data table files of the layer L0 to search for the specific key; and
if the specific key is not found in the data table files of the layer Li, searching in a specific data table file of the layer Li+1 until a layer Ln is searched, or until the specific key is found and the key-value data corresponding to the specific key is read. Wherein, the specific data table file is a data table file corresponding to a key value range which contains the specific key.

Wherein, the process of reading the key-value data of the specific key from any data table file includes:
reading offset data, signature data, and parameter information of a perfect hash in the data table file, where the parameter information of the perfect hash includes a first parameter and a second parameter of a perfect hash corresponding to each key in the data table file;
determining a first hash value and a second hash value of the specific key;
based on the first hash value and the second hash value of the specific key, and the parameter information of the perfect hashes, determining an index of a slot corresponding to the specific key;
based on the first hash value or the second hash value of the specific key, determining signature information corresponding to the specific key;
searching the signature data based on the signature information corresponding to the specific key, and if matched signature information is not found, determining that the specific key is not present in the data table file, and returning information for prompting the absence of key-value data;
if the matched signature information is found, reading key-value data in a slot in a corresponding storage block according to the index of the slot and the offset data; and
if the specific key is the same as a key in the read key-value data, returning the read key-value data, and otherwise, returning the information for prompting the absence of the key-value data.

Specifically, it may be seen, according to the structural features of the LSM-Tree and the data merging flow in the embodiments, that data at an upper layer is more recent, and a query flow thus proceeds in sequence from top to bottom:
a memory table is searched first, and since the memory table is generally used for dynamic updating, data structures such as SkipList, Vector and HashTable are generally selected. For a specified key (i.e., a key to be queried), a search is performed according to a search algorithm of the key. If the search is successful, a result is returned, and otherwise, the persisted data table file needs to be searched.

The data table files are sequentially searched from an upper layer to a lower layer. If a matched key is not found in a layer L_i, a search is continued in the next layer, i.e., a layer L_(i+1), until matching is successful or the last layer is reached. Hence, a whole data search process is completed.

The layer L0 is searched first, and since data files in the L0 are not arranged in order, all the data files in the layer L0 need to be traversed from the new to the old. For non-layer L0 data, the data table files are arranged in monotonically ascending order of keys, and a data file of a range including the specified key is selected to be searched.

When any data table file is searched for the specified key, index information is loaded from footer of the data file to a memory, which includes: parameter information of a perfect hash index, offset data of blocks, and signature data. Thereafter, a hash_1 and a hash_2 of the specified key are calculated, an index of a slot corresponding to the specified key is calculated by means of the formula 2, and corresponding signature information is calculated by means of the formula 3. Pieces of signature information corresponding to slots are compared. If matching is not achieved, it is determined that the value of the specified key is certainly not present in the current data table. If the matching is achieved, according to block positions corresponding to the slots, blocks are read from the data table file and parsed to obtain content of the corresponding slots. If a key obtained by means of parsing is identical to the specified key, the search is successful, and otherwise, absence is returned. Hence, the search in the data files is completed.

The solution provided in the present application has efficient point query performance, where at most one disk IO operation is performed in one instance of query, and data query latency is thus predictable. A system requiring low and stable query latency can achieve significant benefits. Regarding current solutions that use range indexing, the query complexity is O(log n), the query latency is relatively high, and predictable query latency cannot be provided, which may result in a significant variance of query latency for different keys.

In some solutions, full storage position indexes of data are established in a memory, which may also theoretically achieve at most one disk IO overhead per query. However, compared to the solution provided in the present application, such solutions involve significant memory overheads. In the solution provided in the present application, an in-memory index only retains parameter information of a perfect hash function, which allows each key to only occupy approximately 2 bytes, and thus, compared to the existing solutions in the same memory environment, a larger volume of data can be stored.

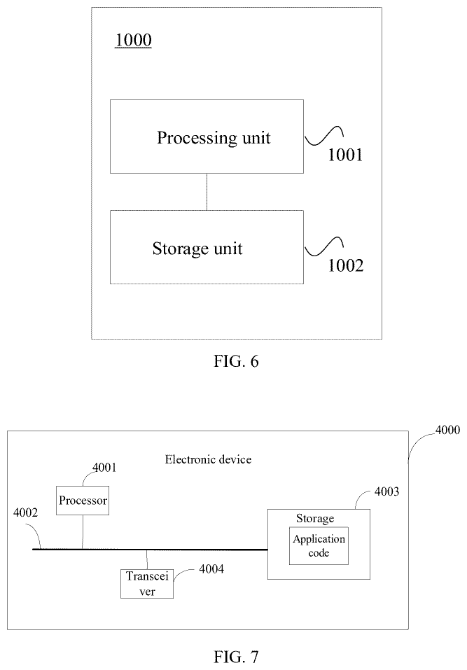

An embodiment of the present application provides a data processing apparatus. As shown FIG. 6, the data processing apparatus 1000 may include: a processing unit 1001 and a storage unit 1002.

The processing unit 1001 is configured to use a first hash function and a second hash function to encode, into a first hash value and a second hash value, each key in key-value data to be stored; and traverse first hash values and second hash values of all keys in the key-value data to be stored, and determine parameter information of a perfect hash corresponding to the key-value data to be stored, wherein the parameter information of the perfect hash includes: an index of a storage unit (slot) corresponding to each key.

The storage unit 1002 is configured to store the key-value data to be stored according to the index of the slot corresponding to each key.

Furthermore, when the parameter information of the perfect hash corresponding to the key-value data to be stored is determined, the processing unit 1001 is specifically configured to:
group all the keys in the key-value data to be stored into a plurality of hash buckets;
sort the plurality of hash buckets in descending order of the number of keys in each bucket; and
traverse the plurality of hash buckets according to the sorting of the plurality of hash buckets, and determine the parameter information of the perfect hash corresponding to each hash bucket.

Furthermore, the parameter information of the perfect hash further includes: a first parameter and a second parameter of the perfect hash corresponding to each hash bucket.

When the parameter information of the perfect hash corresponding to each hash bucket is determined, the processing unit 1001 is specifically configured to: determine a first parameter and a second parameter of a perfect hash corresponding to the current hash bucket, and an index of a slot corresponding to each key in the current hash bucket.

Wherein, the first parameter and the second parameter of the perfect hash corresponding to the current hash bucket enable the slot corresponding to each key in the current hash bucket to be unoccupied.

Furthermore, if the current hash bucket is a first sorted hash bucket among the plurality of hash buckets, when the parameter information of the perfect hash corresponding to the current hash bucket is determined, the processing unit 1001 is specifically configured to:
for each key in the current hash bucket, determine an index of a slot corresponding to the key according to the first hash value and the second hash value of the key, an initial perfect hash table, and a first initial parameter and second initial parameter which are randomly selected;
if the slot corresponding to each key in the current hash bucket is unoccupied, determine the first initial parameter to be the first parameter of the current hash bucket, and the second initial parameter to be the second parameter of the current hash bucket; and
if a slot corresponding to a first key in the current hash bucket has been occupied, repeatedly perform the following steps:
reselecting a first initial parameter and a second initial parameter;
determining an index of a slot corresponding to each key according to the first hash value and the second hash value of each key in the current hash bucket, the reselected first initial parameter and second initial parameter, and the initial perfect hash table;
determining whether the slot corresponding to each key is occupied; and
if the slot corresponding to each key is unoccupied, determining the reselected first initial parameter to be the first parameter of the current hash bucket, and the reselected second initial parameter to be the second parameter of the current hash bucket.

Furthermore, if the current hash bucket is not the first sorted hash bucket among the plurality of hash buckets, when the parameter information of the perfect hash corresponding to the current hash bucket is determined, the processing unit 1001 is specifically configured to:
for each key in the current hash bucket, determine an index of a slot corresponding to the key according to the first hash value and the second hash value of the key, an initial perfect hash table, and a first parameter and a second parameter which correspond to the previous hash bucket;
if the slot corresponding to each key in the current hash bucket is unoccupied, determine the first parameter corresponding to the previous hash bucket to be the first parameter of the current hash bucket, and the second parameter corresponding to the previous hash bucket to be the second parameter of the current hash bucket; and
if a slot corresponding to a second key in the current hash bucket has been occupied, repeatedly perform the following steps:
reselecting a first parameter and a second parameter;
determining an index of a slot corresponding to each key according to the first hash value and the second hash value of each key in the current hash bucket, the reselected first parameter and second parameter, and the initial perfect hash table;
determining whether the slot corresponding to each key is occupied; and
if the slot corresponding to each key is unoccupied, determining the reselected first parameter to be the first parameter of the current hash bucket, and the reselected second parameter to be the second parameter of the current hash bucket.

Furthermore, if the repeatedly performed steps have been performed a preset number of times, and a slot corresponding to at least one key in the current hash bucket is occupied, it is determined that the first parameter and the second parameter which correspond to the current hash bucket are not determined.

Furthermore, if a first parameter and a second parameter which correspond to at least one hash bucket among the plurality of hash buckets are not determined, the processing unit 1001 is further configured to:
repeatedly perform the following steps until a first parameter and a second parameter which correspond to each hash bucket among the plurality of hash buckets are determined:
expanding the initial perfect hash table according to a preset step size, so as to obtain a perfect hash table;
for each key in a first hash bucket, determining an index of a slot corresponding to each key according to a first hash value and a second hash value of each key, the acquired first parameter and second parameter, and the perfect hash table;
determining whether the slot corresponding to each key is occupied; and
if the slot corresponding to each key is unoccupied, determining the acquired first parameter to be a first parameter of the first hash bucket, and the acquire second parameter to be a second parameter of the first hash bucket; and
if a slot corresponding to a third key in the first hash bucket has been occupied, repeatedly performing the following steps:
re-acquiring a first parameter and a second parameter;
determining an index of a slot corresponding to each key according to the first hash value and the second hash value of each key, the re-acquired first parameter and second parameter, and the perfect hash table;
determining whether the slot corresponding to each key is occupied; and
if the slot corresponding to each key is unoccupied, determining the re-acquired first parameter to be the first parameter of the first hash bucket, and the re-acquired second parameter to be the second parameter of the first hash bucket.

Furthermore, the storage unit 1002 is specifically configured to: write the key-value data to be stored into at least one storage block according to the index of the slot corresponding to each key, where the number of slots stored in each storage block is determined based on the size of the unit of storage of a storage device; and write the at least one storage block into the storage device after compressing the at least one storage block.

Furthermore, the storage unit 1002 is specifically configured to: write length information of each slot into a head position of the corresponding storage block according to the index of the slot corresponding to each key, and sequentially write key-value data in each slot into the corresponding storage block.

Furthermore, the processing unit 1001 is further configured to: record file offset position information of each storage block, so as to obtain offset data; and determine a part of the first hash value or the second hash value of each key to be signature information of the key, so as to obtain signature data.

The storage unit 1002 is specifically configured to: generate a data table file based on the at least one compressed storage block, the offset data, the signature data, the parameter information of the perfect hash, and attribute information of a data table; and write the data table file into the storage device using a log-structured-merge-tree (LSM-Tree) structure.

Furthermore, when writing the data table file into the storage device using the LSM-Tree structure, the storage unit 1002 is specifically configured to:
write the data table file into the layer L0 of the LSM-Tree structure; and
if a first data file stored in a layer Li reaches a first preset threshold, merging the first data file into a layer Li+1, where i is 0 to n, and n is a positive integer greater than 1.

Furthermore, the merging the first data file into the layer Li+1 includes:
if the layer Li+1 does not store any data, directly writing the first data file into the layer Li+1; and
if the layer Li+1 has stored a second data file, respectively dividing the first data file and the second data file into S data segments according to hash values of keys, and performing the following operations for a jth data segment of the first data file and a jth data segment of the second data file:
acquiring a first hash value and a second hash value of all keys in the two jth data segment;
determining an index of a slot corresponding to each key according to the first hash value and the second hash value of each key; and
determining a corresponding operation according to the key-value data in each slot,
where S is a preset value greater than 1, and j is 1 to S.

Furthermore, the determining the corresponding operation according to the key-value data in each slot includes:
if the current slot is empty, determining not to perform any operation;
if the key-value data in the current slot is key-value data in the first data file or key-value data in the second data file, determining to perform the step of writing the key-value data in the current slot into the storage device according to an index of the current slot; and
if the key-value data in the current slot includes the key-value data in the first data file and the key-value data in the second data file, determining to write new key-value data into the current slot, and to perform a step of writing the new key-value data in the current slot into the storage device according to the index of the current slot.

Wherein, the new key-value data is obtained based on the key-value data in the first data file and the key-value data in the second data file.

Furthermore, the processing unit 1001 is further configured to: if the volume of key-value data written into a first memory table reaches a second preset threshold, mark the first memory table as in a non-updatable state, and determine the key-value data in the first memory table to be the key-value data to be stored.

Furthermore, the data processing apparatus further includes: a reading unit 1003, which is configured to, in response to a received read instruction, read corresponding key-value data from data table files of the storage device, wherein, the read instruction is used for instructing the reading of key-value data of a specific key.

Furthermore, the reading unit 1003 is specifically configured to:
if the specific key is found in the memory table, read the key-value data corresponding to the specific key;
if the specific key is not found in the memory table, traverse data table files of the layer L0 to search for the specific key; and
if the specific key is not found in the data table files of the layer Li, search a specific data table file of the layer Li+1 until a layer Ln is searched, or until the specific key is found and the key-value data corresponding to the specific key is read, wherein the specific data table file is a data table file corresponding to a key value range which contains the specific key.

Furthermore, when reading the key-value data of the specific key from any data table file, the reading unit 1003 is specifically configured to:
read offset data, signature data, and parameter information of a perfect hash in the data table file, where the parameter information of the perfect hash includes a first parameter and a second parameter of a perfect hash corresponding to each key in the data table file;
determine a first hash value and a second hash value of the specific key;
based on the first hash value and the second hash value of the specific key, and the parameter information of the perfect hashes, determine an index of a slot corresponding to the specific key;
based on the first hash value or the second hash value of the specific key, determine signature information corresponding to the specific key;
search the signature data based on the signature information corresponding to the specific key, and if matched signature information is not found, determine that the specific key is not present in the data table file, and return information for prompting the absence of key-value data;
if the matched signature information is found, read key-value data in a slot in a corresponding storage block according to the index of the slot and the offset data; and
if the specific key is the same as a key in the read key-value data, return the read key-value data, and otherwise, return the information for prompting the absence of the key-value data.

The apparatus in the embodiment of the present application may perform the method provided in the embodiments of the present application, and the implementation principles thereof are similar to each other. Actions performed by the modules in the apparatus in the embodiment of the present application correspond to the steps of the method in the embodiments of the present application, and the detailed functional descriptions of the modules of the apparatus can refer to the above description in the corresponding method, which will not be repeated here.

An embodiment of the present application provides an electronic device, including a storage, a processor and a computer program stored on the storage. The processor executes the computer program to implement the steps of the data processing method and, compared to the existing techniques, may realize that: an index of a slot corresponding to each key is determined by means of traversing first hash values and second hash values of all keys in key-value data to be stored, and the key-value data to be stored is stored according to the index of the slot corresponding to each key, such that the size of a data index may be reduced, and the disk IO overheads are reduced during data query, thereby improving the query efficiency, and thus solving the problems of the disk IO overheads being large and the query efficiency being low during data query.

In an optional embodiment, an electronic device is provided, as shown in FIG. 7. The electronic device 4000 as shown in FIG. 7 includes: a processor 4001 and a storage 4003. The processor 4001 is connected to the storage 4003, for example, through a bus 4002. Optionally, the electronic device 4000 may further include a transceiver 4004. The transceiver 4004 may be used for data exchange, for example, transmission and/or reception of data, between the electronic device and other electronic device. It should be noted that, in practical applications, the number of transceiver 4004 is not limited to one, and the structure of the electronic device 4000 does not constitute any limitations to the embodiments of the present application.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various exemplary logical blocks, modules and circuits described in connection with the present application. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 7. However, it does not mean that there is only one bus or one type of buses.

The storage 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The storage 4003 is used to store computer program for executing the solutions of the present application, and is controlled by the processor 4001. The processor 4001 is used to execute the computer program stored in the storage 4003 to implement the solution provided in any method embodiment described above.

Embodiments of the present application provide a computer-readable storage medium having a computer program stored on the computer-readable storage medium, the computer program, when executed by a processor, implements the steps and corresponding contents of the foregoing method embodiments.

Embodiments of the present application also provide a computer program product including a computer program, the computer program when executed by a processor realizing the steps and corresponding contents of the preceding method embodiments.

It should be understood that while the flow diagrams of embodiments of the present application indicate the individual operational steps by arrows, the order in which these steps are performed is not limited to the order indicated by the arrows. Unless explicitly stated herein, in some implementation scenarios of embodiments of the present application, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the present application are not limited thereto.

The above descriptions are merely optional implementations for some implementation scenarios of the present application. It should be noted that, for those of ordinary skill in the art, adopting other similar implementation means based on the technical idea of the present application without departing from the technical concept of the solution of the present application also falls within the scope of protection of the embodiments of the present application.

1. A data processing method, comprising:
using a first hash function and a second hash function to encode, each key in key-value data to be stored into a first hash value and a second hash value;
traversing first hash values and second hash values of all keys in the key-value data to be stored, and determining parameter information of a perfect hash corresponding to the key-value data to be stored, wherein the parameter information of the perfect hash comprises: an index of a slot corresponding to each key; and
for the key-value date to be stored, writing length information of each slot into a head position of the corresponding storage block according to the index of the slot corresponding to each key, and sequentially writing key-value data in each slot into the corresponding storage block, wherein the number of slots stored in each storage block is determined based on the size of the unit of storage of a storage device;
writing the at least one storage block into the storage device after compressing the at least one storage block;
recording file offset position information of each block, so as to obtain offset data;
determining a part of the first hash value or the second hash value of each key to be signature information of the key, so as to obtain signature data,
wherein the writing the at least one storage block into the storage device after compressing the at least one storage block comprises:
generating a data table file based on the at least one compressed storage block, the offset data, the signature data, the parameter information of the perfect hash, and attribute information of a data table;
writing the data table file into a layer Li of a log-structured-merge-tree (LSM-Tree) structure, if a first data file stored in a layer Li reaches a first preset threshold, merging the first data file into a layer Li+1, wherein i is 0 to n, and n is a positive integer greater than 1;
wherein the merging the first data file into the layer Li+1 comprises:
if the layer Li+1 does not store any data, directly writing the first data file into the layer Li+1;
if the layer Li+1 has stored a second data file, respectively dividing the first data file and the second data file into S data segments according to hash values of keys, and performing the following operations for a jth data segment of the first data file and a jth data segment of the second data file;
acquiring a first hash value and a second hash value of all keys in the two jth data segments;
determining an index of a slot corresponding to each key according to the first hash value and the second hash value of the key; and
determining a corresponding operation according to the key-value data in each slot,
wherein S is a preset value greater than 1, and j is 1 to S.

2. The method according to claim 1, wherein the determining the parameter information of the perfect hash corresponding to the key-value data to be stored comprises:
grouping all the keys in the key-value data to be stored into a plurality of hash buckets;
sorting the plurality of hash buckets in descending order of the number of keys in each hash bucket; and
traversing the plurality of hash buckets according to the sorting of the plurality of hash buckets, and determining the parameter information of the perfect hash corresponding to each hash bucket.

3. The method according to claim 2, wherein the parameter information of the perfect hash further comprises: a first parameter and a second parameter of the perfect hash corresponding to each hash bucket; and
the determining the parameter information of the perfect hash corresponding to each hash bucket comprises:
determining a first parameter and a second parameter of a perfect hash corresponding to the current hash bucket, and an index of a slot corresponding to each key in the current hash bucket; and
wherein the first parameter and the second parameter of the perfect hash corresponding to the current hash bucket enable the slot corresponding to each key in the current hash bucket to be unoccupied.

4. The method according to claim 3, wherein if the current hash bucket is a first sorted hash bucket among the plurality of hash buckets, the determining the parameter information of the perfect hash corresponding to the current hash bucket comprises:
for each key in the current hash bucket, determining an index of a slot corresponding to the key according to the first hash value and the second hash value of the key, an initial perfect hash table, and a first initial parameter and second initial parameter which are randomly selected;
if the slot corresponding to each key in the current hash bucket is unoccupied, determining the first initial parameter to be the first parameter of the current hash bucket, and the second initial parameter to be the second parameter of the current hash bucket; and
if a slot corresponding to a first key in the current hash bucket has been occupied, repeatedly performing the following steps:
reselecting a first initial parameter and a second initial parameter;
determining an index of a slot corresponding to each key according to the first hash value and the second hash value of the key in the current hash bucket, the reselected first initial parameter and second initial parameter, and the initial perfect hash table;
checking whether the slot corresponding to each key is occupied; and
if the slot corresponding to each key is unoccupied, determining the reselected first initial parameter to be the first parameter of the current hash bucket, and the reselected second initial parameter to be the second parameter of the current hash bucket.

5. The method according to claim 3, wherein if the current hash bucket is not the first sorted hash bucket among the plurality of hash buckets, the determining the parameter information of the perfect hash corresponding to the current hash bucket comprises:
for each key in the current hash bucket, determining an index of a slot corresponding to the key according to the first hash value and the second hash value of the key, an initial perfect hash table, and a first parameter and a second parameter which correspond to the previous hash bucket;
if the slot corresponding to each key in the current hash bucket is unoccupied, determining the first parameter corresponding to the previous hash bucket to be the first parameter of the current hash bucket, and the second parameter corresponding to the previous hash bucket to be the second parameter of the current hash bucket; and
if a slot corresponding to a second key in the current hash bucket has been occupied, repeatedly performing the following steps:
reselecting a first parameter and a second parameter;
determining an index of a slot corresponding to each key according to the first hash value and the second hash value of the key in the current hash bucket, the reselected first parameter and second parameter, and the initial perfect hash table;
checking whether the slot corresponding to each key is occupied; and
if the slot corresponding to each key is unoccupied, determining the reselected first parameter to be the first parameter of the current hash bucket, and the reselected second parameter to be the second parameter of the current hash bucket.

6. The method according to claim 4, wherein if the repeatedly performed steps have been performed limited times, and a slot corresponding to at least one key in the current hash bucket is occupied, it is determined that the first parameter and the second parameter which correspond to the current hash bucket are not determined.

7. The method according to claim 6, wherein if the first parameter and the second parameter which correspond to at least one hash bucket among the plurality of hash buckets are not determined, the method further comprises:
repeatedly performing the following steps until a first parameter and a second parameter which correspond to each hash bucket among the plurality of hash buckets are determined:
expanding the initial perfect hash table according to a preset step size, so as to obtain a perfect hash table;
for each key in a first hash bucket, determining an index of a slot corresponding to the key according to a first hash value and a second hash value of the key, the acquired first parameter and second parameter, and the perfect hash table;
checking whether the slot corresponding to each key is occupied;
if the slot corresponding to each key is unoccupied, determining the acquired first parameter to be a first parameter of the first hash bucket, and the acquire second parameter to be a second parameter of the first hash bucket; and
if a slot corresponding to a third key in the first hash bucket has been occupied, repeatedly performing the following steps:
re-acquiring a first parameter and a second parameter;
determining an index of a slot corresponding to each key according to the first hash value and the second hash value of the key, the re-acquired first parameter and second parameter, and the perfect hash table;
checking whether the slot corresponding to each key is occupied; and
if the slot corresponding to each key is unoccupied, determining the re-acquired first parameter to be the first parameter of the first hash bucket, and the re-acquired second parameter to be the second parameter of the first hash bucket.

8-12. (canceled)

13. The method according to claim 1, wherein the determining the corresponding operation according to the key-value data in each slot comprises:
if the current slot is empty, no operation is performed;
if the key-value data in the current slot is key-value data in the first data file or key-value data in the second data file, determining to perform the step of writing the key-value data in the current slot into the storage device according to an index of the current slot; and
if the key-value data in the current slot comprises the key-value data in the first data file and the key-value data in the second data file, determining to write new key-value data into the current slot, and to perform a step of writing the new key-value data in the current slot into the storage device according to the index of the current slot,
wherein the new key-value data is obtained based on the key-value data in the first data file and the key-value data in the second data file.

14. The method according to claim 1, further comprising:
if the volume of key-value data written into a first memory table reaches a second preset threshold, marking the first memory table as in a non-updatable state, and determining the key-value data in the first memory table to be the key-value data to be stored.

15. The method according to claim 1, further comprising:
in response to a received read instruction, reading corresponding key-value data from data table files of the storage device, wherein the read instruction is used for instructing the reading of key-value data of a specific key.

16. The method according to claim 15, wherein the process of reading the key-value data of the specific key comprises:
if the specific key is found in the memory table, reading the key-value data corresponding to the specific key;
if the specific key is not found in the memory table, traversing data table files of the layer L0 to search for the specific key; and
if the specific key is not found in the data table files of the layer Li, then searching a specific data table file of the layer Li+1 until a layer Ln is searched, or until the specific key is found and the key-value data corresponding to the specific key is read, wherein the specific data table file is a data table file corresponding to a key value range which contains the specific key.

17. The method according to claim 16, wherein the process of reading the key-value data of the specific key from any data table file comprises:
reading offset data, signature data, and parameter information of a perfect hash in the data table file, wherein the parameter information of the perfect hash comprises a first parameter and a second parameter of a perfect hash corresponding to each key in the data table file;
determining a first hash value and a second hash value of the specific key;
based on the first hash value and the second hash value of the specific key, and the parameter information of the perfect hash, determining an index of a slot corresponding to the specific key;
based on the first hash value or the second hash value of the specific key, determining signature information corresponding to the specific key;
searching the signature data based on the signature information corresponding to the specific key, and if matched signature information is not found, determining that the specific key is not present in the data table file, and returning information for prompting the absence of key-value data;
if the matched signature information is found, reading key-value data in a slot in a corresponding storage block according to the index of the slot and the offset data; and
if the specific key is the same as a key in the read key-value data, returning the read key-value data, and otherwise, returning the information for prompting the absence of the key-value data.

18. A data processing apparatus, comprising:
a processing unit, which is configured to use a first hash function and a second hash function to encode each key in key-value data to be stored, into a first hash value and a second hash value; and traverse first hash values and second hash values of all keys in the key-value data to be stored, and determine parameter information of a perfect hash corresponding to the key-value data to be stored, wherein the parameter information of the perfect hash comprises: an index of a slot corresponding to each key; and
a storage unit, which is configured to: for the key-value date to be stored, write length information of each slot into a head position of the corresponding storage block according to the index of the slot corresponding to each key, write the at least one storage block into the storage device after compressing the at least one storage block, wherein the number of slots stored in each storage block is determined based on the size of the unit of storage of a storage device;
the processing unit is also configured to record file offset position information of each storage block, so as to obtain offset data; determine a part of the first hash value or the second hash value of each key to be signature information of the key, so as to obtain signature data,
the storage unit is specifically configured to generate a data table file based on the at least one compressed storage block, the offset data, the signature data, the parameter information of the perfect hash, and attribute information of a data table, and write the data table file into a layer Li of a log-structured-merge-tree (LSM-Tree) structure, if a first data file stored in a layer Li reaches a first preset threshold, merge the first data file into a layer Li+1, wherein i is 0 to n, and n is a positive integer greater than 1;
wherein if the layer Li+1 does not store any data, directly write the first data file into the layer Li+1;
if the layer Li+1 has stored a second data file, respectively divide the first data file and the second data file into S data segments according to hash values of keys, and perform the following operations for a jth data segment of the first data file and a jth data segment of the second data file;
acquire a first hash value and a second hash value of all keys in the two jth data segments;
determine an index of a slot corresponding to each key according to the first hash value and the second hash value of the key; and
determine a corresponding operation according to the key-value data in each slot,
wherein S is a preset value greater than 1, and j is 1 to S.

19. An electronic device, comprising: a storage, a processor and a computer program, which is stored on the storage, wherein the processor executes the computer program to implement the data processing method according to claim 1.

20. (canceled)
